(19) United States
(12) Patent Application Publication
(10) Pub. No.: US 2026/0058516 A1
(43) Pub. Date: Feb. 26, 2026

(54) SHAFT GROUNDING ASSEMBLY

(71) Applicant: Carl Freudenberg KG, Weinheim (DE)

(72) Inventors: Marlene BANTZ, Edesheim (DE); Herweck TIM, Lampertheim (DE); Stefan MORGENSTERN, Wald-Michelbach (DE); Sören NEUBERGER, Hockenheim (DE)

(21) Appl. No.: 19/102,433

(22) PCT Filed: Aug. 8, 2023
(86) PCT No.: PCT/EP2023/071900

§ 371 Date: Feb. 10, 2025

(30) Foreign Application Priority Data
Aug. 12, 2022 (DE) 10 2022 120 413.8

(51) Int. Cl. H02K 5/124; F16J 15/3228; F16J 15/3284; F16J 15/34

(52) U.S. Cl. CPC H02K 5/124; F16J 15/3228; F16J 15/3284; F16J 15/3416

(57) ABSTRACT

A shaft earthing arrangement including a housing which receives a shaft and a fluid. The shaft is associated with an earthing ring configured to produce an electrically conductive contact between the shaft and housing. The earthing ring has a disk-shaped contact member supported in a lip-like manner on a covering of the shaft. A first contact face is formed from the contact member and a second contact face is formed from the shaft. At least one of the first contact face and the second contact face is provided with a surface structuring.

### CROSS REFERENCE TO RELATED APPLICATIONS

This application is a U.S. National Phase application under 35 U.S.C. § 371 of International Application No. PCT/EP2023/071900, filed on Aug. 8, 2023, and claims benefit to German Patent Application No. DE 10 2022 120 413.8, filed on Aug. 12, 2022. The International Application was published in German on Feb. 15, 2024 as WO 2024/033343 A1 under PCT Article 21(2).

### FIELD

The invention relates to a shaft earthing arrangement.

### BACKGROUND

An arrangements is known, for example, from DE 10 2016 010926 A1, and is used to earth a shaft which is supported in a housing. In order to improve the electromagnetic compatibility of a device, for example a vehicle, the earthing ring produces an electrically conductive connection between the shaft and housing so that electromagnetic waves, in particular high-frequency electromagnetic signals, cannot be propagated outward via the shaft beyond the housing. Such electromagnetic signals may influence electronic components of a vehicle or electronic devices which are also carried with the vehicle in an unfavorable manner.

As a result of a voltage flash-over, mechanical damage can also be caused particularly to bearings.

In the previously known shaft earthing arrangements, however, it is necessary in this case for the earthing ring not to be influenced by fluids, such as lubricating oils or lubricating greases. In the previously known systems, there is the risk that the electrically conductive contact between the earthing ring and the shaft may be interrupted by the influence of fluids or that the electrically conductive ring which is slidingly supported on the shaft may lose the electrically conductive properties. The electrical resistance of the arrangement can thereby be increased and the effect of the arrangement is impaired.

### SUMMARY

In an embodiment, the present disclosure provides a shaft earthing arrangement comprising a housing which receives a shaft and a fluid. The shaft is associated with an earthing ring configured to produce an electrically conductive contact between the shaft and housing. The earthing ring has a disk-shaped contact member supported in a lip-like manner on a covering of the shaft. A first contact face is formed from the contact member and a second contact face is formed from the shaft. At least one of the first contact face and the second contact face is provided with a surface structuring.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a cross section of a shaft earthing arrangement according to an embodiment of the present disclosure;

FIG. 2 shows a view of an earthing ring in detail;

FIG. 3 shows a view of an earthing ring with a resilient member in the form of an elastomer lip;

FIG. 4 shows a view of an earthing ring with fluid directing elements;

FIG. 5 shows a view of an earthing ring as a cassette arrangement;

FIG. 6 shows a view of an earthing ring with a conveying structure which is introduced into the resilient means; and

FIG. 7 shows in detail different embodiments of the present disclosure of the surface structuring.

### DETAILED DESCRIPTION

An embodiment of the present disclosure provides a shaft earthing arrangement which is robust and which ensures a reliable electrical contacting of the earthing ring and the shaft.

The shaft earthing arrangement according to an embodiment comprises a housing which receives a shaft and a fluid, wherein the shaft is associated with an earthing ring which produces an electrically conductive contact between the shaft and housing, wherein the earthing ring has a disk-shaped contact member which is supported in a lip-like manner on the covering of the shaft, wherein a first contact face is formed from the contact member and a second contact face is formed from the shaft, wherein at least one of the two contact faces is provided with a surface structuring.

In the shaft earthing arrangement according to an embodiment, a fluid which can be, for example, a lubricating oil or a lubricating grease, is located in the housing beside the shaft. In this case, the lubricating oil can contact the shaft and also come into contact with the earthing ring. As a result of the surface structuring which is introduced in at least one contact face, an electrically conductive contact between the shaft and earthing ring is also ensured when the fluid which is located in the housing reaches a location between the two contact faces. An electrically conductive contact between the shaft and the housing is also thereby ensured when the earthing ring is also acted on with fluid. It is thereby provided to arrange the earthing ring inside a housing. Furthermore, an embodiment provides the earthing ring to be arranged directly in the housing and not to be screened against the fluid via a sealing ring or the like.

As a result of this configuration, it is also made possible for the shaft to be supported via a ball bearing in the housing, wherein the earthing ring is associated with the ball bearing at the side facing the housing interior. As a result of this arrangement, the earthing ring conducts away electric currents introduced into the shaft and electromagnetic signals into the housing before they reach the ball bearing. It is thereby provided to protect the ball bearings from the influence of spark erosion as a result of voltage flash-over and circular currents. The quiet running and service-life are thereby improved and it is also provided to extend maintenance intervals. Overall, failures of the complete arrangement can be avoided.

In that the earthing ring of the shaft earthing arrangement according to an embodiment is arranged directly in the housing which is acted on with fluid, additional dynamic sealing locations which encapsulate the earthing ring in conventional earthing systems can be dispensed with. Friction-generating sealing locations are thereby dispensed with, which involves an increase of the degree of efficiency of the system.

The shaft earthing arrangement according to an embodiment is particularly suitable for use in vehicles, in particular in electric vehicles. At that location, for example, the shaft earthing arrangement can be arranged in electric motor housings or gear mechanism housings.

The contact member can have a matrix comprising nonwoven fabric. In this case, the contact member which has the matrix made of nonwoven can be impregnated with PTFE and provided with electrically conductive particles. Electrically conductive particles are, for example, silver and/or graphite and can be in the form of threads, particles or powders. In principle, highly conductive materials, such as copper, nickel, gold or the like, are also provided. Depending on the configuration, the nonwoven is already electrically conductive, wherein the conductivity can be improved by adding the additives mentioned. In this embodiment, the contact member is easy and cheap to produce and also has good electrical conductivity in addition to low-friction and low-wear sliding properties.

The contact member can be in the form of a disk, wherein radially inwardly extending recesses are formed in the external circumference. An embodiment also provides for the recesses to be orientated in the direction of the main rotation direction. The recesses can be in the form of slots.

According to an embodiment, the surface structuring is introduced into the second contact face. Accordingly, the surface structuring is introduced into the covering of the shaft. In this case, it is advantageous for the surface structuring to be particularly durable and to be subject only to slight wear.

The surface structuring can be introduced directly into the shaft. An embodiment also provides for a sleeve to be pushed onto the shaft, wherein the sleeve is secured on the shaft in an electrically conductive manner and preferably with a press-fit. In this embodiment, the surface structuring can be applied externally to the sleeve and the earthing ring is in contact with the sleeve.

In this case, the surface structuring can comprise grooves which extend in the circumferential direction. In this case, the grooves can extend annularly or in the manner of a screw thread about the shaft.

It has been found that, as a result of the surface structuring, it is ensured that the earthing ring is always in abutment against the shaft and thereby produces an electrical contacting between the shaft and housing. If fluid, for example, a lubricating oil, is introduced into the region of the contact faces, the surface structuring brings about a transport of the fluid so that the fluid does not remain between the two contact faces and thereby raises the earthing ring off the shaft. As a result of the surface structuring, a pump action can accordingly be brought about. As a result of the constant transport, it is ensured that the earthing ring is always in abutment against the shaft. The advantageous effect is also achieved when the surface structuring is also non-directed and has any structure, as produced, for example, by roughening or grinding.

According to an embodiment, the surface structuring is introduced into the first contact face. In this embodiment, the surface structuring is accordingly introduced into the contact member. In this embodiment, the surface structuring can also comprise grooves which extend in this embodiment concentrically on the contact face which is associated with the shaft. The grooves can be introduced in the first contact face in the form of concentric rings, sine waves or in the form of a helix. In this embodiment, it is advantageous for the surface structuring to be able to be introduced into the contact member in a particularly simple and cost-effective manner. This can be carried out, for example, directly during the forming process of the contact member, which is particularly simple when the contact member comprises polymer material.

However, it is particularly also provided for the surface structuring to be pressed into the first contact face. It is thereby provided to introduce the surface structuring into the contact face even after the contact member is formed.

According to an embodiment, the first contact face and the second contact face are provided with a surface structuring. This embodiment ensures an electrically conductive contact between the shaft and housing even under adverse circumstances, for example, with particularly powerful contact with fluid.

A resilient means which presses the contact member against the shaft with resilient pretensioning can be associated with the contact member. The resilient means ensures permanent contact of the earthing ring with the shaft. In this case, the resilient means can be formed by an annular elastomer lip which surrounds the contact member at the external circumference. The elastomer lip can be provided with fluid conveying structures. An embodiment also provides for the elastomer lip to be provided with a thickened portion which extends into the intermediate spaces, which are formed by the recesses, of the contact member. A particularly good conveying action is produced when the elastomer lip is provided with conveying structures in the region of the thickened portion.

The surface structuring which is introduced into the first contact face and/or second contact face can form an undulating progression when viewed in cross section and can, for example, be in the form of sine waves, square waves or trapezoidal waves.

The contact member can have recesses in which the resilient means projects. In an embodiment, it is particularly provided for the surface structuring to be introduced into the resilient means. In this case, it is particularly advantageous for the surface structuring to be able to be produced particularly simply.

A reliable electrical contacting between the contact member and the shaft with a long service-life at the same time is produced particularly when the height of the surface structuring, that is to say, the distance between the high point and the low point, is between 1 μm and 20 μm. In a preferable embodiment, the depth is between 5 μm and 15 μm. The width of a groove-like structure of the surface structuring, for example the distance between a high point and the adjacent low point, is preferably between 50 μm and 200 μm. In a preferable embodiment, the width is between 75 μm and 150 μm.

The earthing ring can be associated with at least one fluid directing element. In this case, the fluid directing element is associated either with the housing or with the shaft. Preferably, the fluid directing element is arranged on the shaft in a rotationally secure manner. In this embodiment, the fluid directing element acts as a centrifugal ring which limits the quantity of fluid which can be introduced between the two contact faces in dynamic flow terms.

According to another advantageous embodiment, one fluid directing element is arranged at each of the two sides of the earthing ring. Similarly, it is provided for the earthing ring to be in the form of a cassette ring and to have fluid directing elements at both sides, between which an earthing ring is arranged. In this embodiment, it is particularly provided for the fluid directing elements to be arranged on the shaft in a rotationally secure manner while the earthing ring is secured to the housing in a rotationally secure manner.

Another advantageous embodiment makes provision for the earthing ring to have a carrier structure which is secured to the shaft in a rotationally secure manner and which has fluid directing elements in the form of centrifugal faces at both end sides. There is arranged between the two fluid directing elements an additional carrier member which carries a resilient means which presses the contact member at the end side against the inner side of a fluid directing element. This embodiment is suitable for particularly robust uses with a high occurrence of fluid medium.

One embodiment of the shaft earthing arrangement according to the present disclosure is shown below with reference to the Figures.

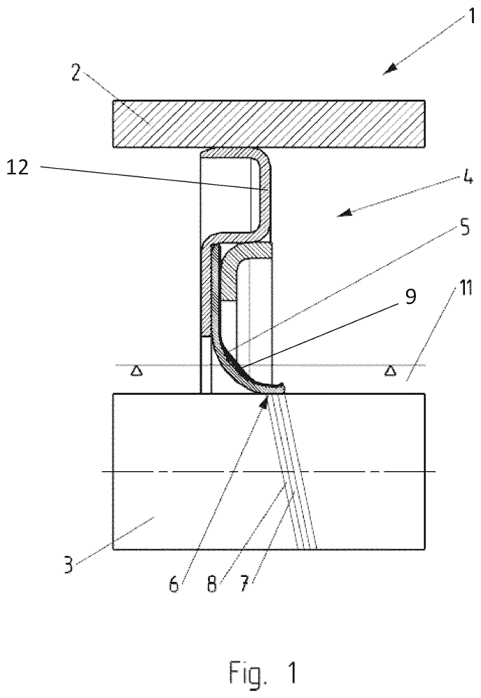

FIG. 1 shows a shaft earthing arrangement 1 comprising a housing 2 which receives a shaft 3 and a fluid 11. The shaft earthing arrangement 1 is in this case a component of an electric motor or gear mechanism of an electric vehicle. The fluid 11 is a lubricating oil in this instance.

The shaft 3 is associated with an earthing ring 4 which produces an electrically conductive contact between the shaft 3 and the housing 2. The earthing ring 4 has a disk-shaped contact member 5 which is supported in a lip-like manner on the covering of the shaft 3. In this case, a first contact face 6 is formed from the contact member 5 and a second contact face 7 is formed from the shaft 3.

The contact member 5 comprises a matrix made of nonwoven fabric which is impregnated with PTFE and which is formed from electrically conductive material. In order to improve the conductivity, electrically conductive material is introduced into the nonwoven. According to a first embodiment, the conductive material comprises silver particles and, according to a second embodiment, graphite powder. A third embodiment comprises a combination of silver particles and graphite powder. The contact member 5 is secured to a carrier member 12 made of electrically conductive material, wherein the carrier member 12 is formed in two pieces and fixes the contact member 5 by means of a clamping connection. The carrier member 12 is secured to the housing 2.

In the present embodiment, a surface structuring 8 is introduced into the second contact face 7. The surface structuring 8 comprises grooves which are formed in a trapezoidal manner when viewed in cross section. The high point and low point of the surface structuring 8 (from the peak to the trough) are spaced apart from each other by 10 μm. Mutually adjacent high points are spaced apart from each other by 100 μm.

The grooves are introduced into the shaft 3 in the form of a screw thread. According to an alternative embodiment, the grooves are introduced into the shaft 3 in an annular manner.

The contact member 5 is associated with a resilient means 9 which presses the contact member 5 against the shaft 3 with resilient pretensioning. In the present embodiment, the resilient means 9 comprises a large number of metal tongues which are arranged in a state distributed uniformly over the circumference and which press the contact member 5 against the shaft 3 in the region of the first contact face 6.

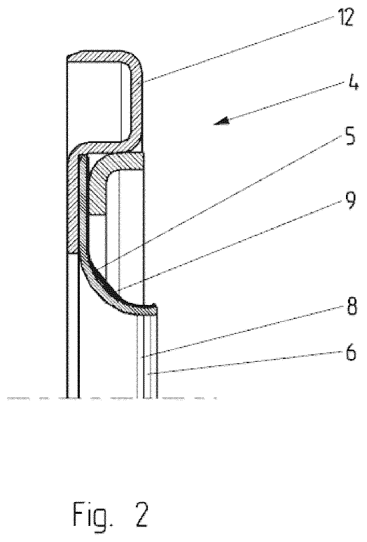

FIG. 2 shows a second embodiment of the earthing ring 4 which is shown in FIG. 1. In this embodiment, the surface structuring 8 is introduced into the first contact face 6 of the contact member 5. This is carried out by pressing in the present embodiment. In this case, the surface structuring 8 comprises a plurality of concentrically arranged circles with protrusions and indentations. Alternatively, the surface structuring 8 can also be of helical form.

According to a third embodiment, both the contact face 7 of the shaft 3 and the contact face 6 of the earthing ring 4 are provided with a surface structuring 6. The surface structuring 6 can be introduced directly into the surface of the shaft 3. Alternatively, a sleeve can be pushed onto the shaft 3, wherein the sleeve is electrically conductive and wherein the surface structuring 6 is introduced into the sleeve externally.

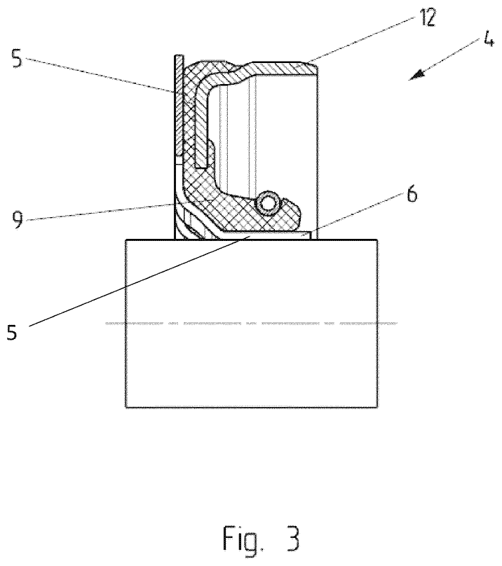

FIG. 3 shows a third embodiment of the earthing ring 4 shown in FIG. 1. In this embodiment, the resilient means 9 is formed by an elastomer lip which moves into abutment externally against the contact member 5. The radial pressing of the resilient means 9 is intensified by an annular coiled spring which is arranged externally on the elastomer lip.

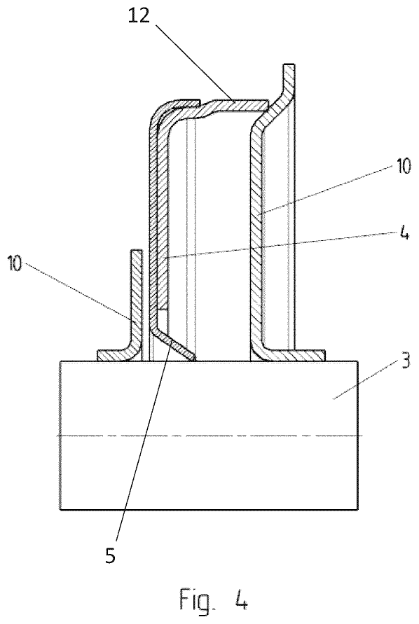

FIG. 4 shows a further development of the shaft earthing arrangement 1 which is shown in FIG. 1. In the present embodiment, both end sides of the earthing ring are associated with disk-shaped fluid directing elements 10. Both fluid directing elements 10 are secured on the shaft 3 in a rotationally secure manner.

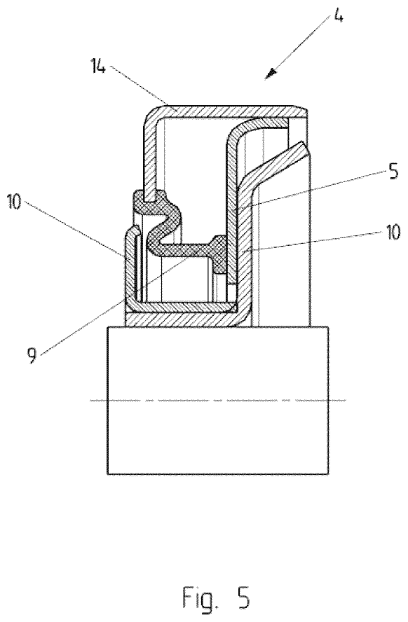

FIG. 5 shows a shaft earthing arrangement 1 in the form of a cassette seal. In this embodiment, the earthing ring 4 has a carrier structure which is secured on the shaft 3 in a rotationally secure manner and which has at both end sides fluid directing elements 10 in the form of centrifugal faces. An additional carrier member 14 which carries a resilient means 9 which presses the contact member 5 against the inner side of a fluid directing element 10 at the end side is arranged between the two fluid directing elements 10.

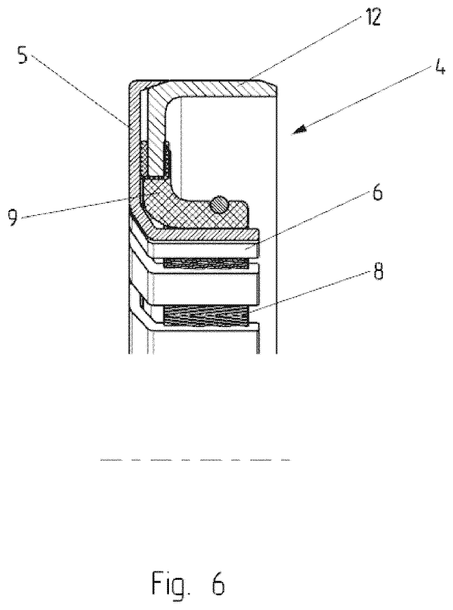

FIG. 6 shows a further development of the earthing ring 4 which is shown in FIG. 3. In the present embodiment, the surface structuring 6 is introduced into the resilient means 9. The contact member 5 has a large number of recesses, in which the resilient means 9 projects, wherein the resilient means 9 has in these regions a thickened portion. The surface structuring 6 of the resilient means 9 is arranged in the regions of the recesses.

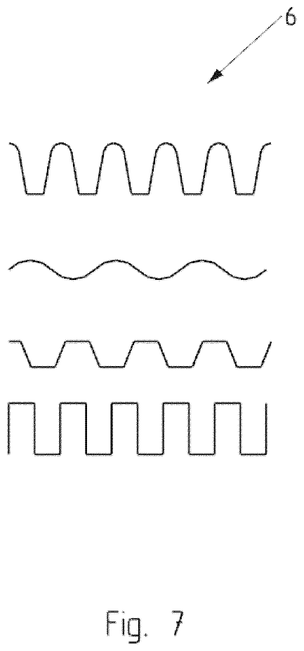

FIG. 7 shows different embodiments of surface structurings 6.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A shaft earthing arrangement comprising:
a housing which receives a shaft; and
a fluid,
wherein the shaft is associated with an earthing ring configured to produce an electrically conductive contact between the shaft and housing, wherein the earthing ring has a disk-shaped contact member supported in a lip-like manner on a covering of the shaft,
wherein a first contact face is formed from the contact member and a second contact face is formed from the shaft, and
wherein at least one of the first contact face and the second contact face is provided with a surface structuring

2: The shaft earthing arrangement as claimed in claim 1, wherein the contact member has a matrix comprising nonwoven fabric.

3: The shaft earthing arrangement as claimed in claim 1, wherein the surface structuring is introduced into the second contact face.

4: The shaft earthing arrangement as claimed in claim 1, wherein the surface structuring comprises grooves which extend in a circumferential direction.

5: The shaft earthing arrangement as claimed in claim 4, wherein the grooves are formed annularly or in a manner of a screw thread.

6: The shaft earthing arrangement as claimed in claim 1, wherein the surface structuring is non-directed.

7: The shaft earthing arrangement as claimed in claim 1, wherein the surface structuring is introduced into the first contact face.

8: The shaft earthing arrangement as claimed in claim 7, wherein the surface structuring is pressed into the first contact face.

9: The shaft earthing arrangement as claimed in claim 1, wherein the contact member is associated with a resilient member which presses the contact member against the shaft with resilient pretensioning.

10: The shaft earthing arrangement as claimed in claim 9, wherein the surface structuring is introduced into the resilient member.

11: The shaft earthing arrangement as claimed in claim 1, wherein fluid directing elements are associated with the earthing ring.

12: The shaft earthing arrangement as claimed in claim 11, wherein the plurality of fluid directing elements comprises two fluid directing elements, wherein a first fluid directing element of the two fluid directing elements is associated with a first end side of the contact member and a second fluid directing element of the two fluid directing elements is associated with a second end side of the contact member.
